(19) United States
(12) Patent Application Publication
(10) Pub. No.: US 2005/0015446 A1
(43) Pub. Date: Jan. 20, 2005

(54) Method and apparatus to remotely control electronic apparatuses over a network

(75) Inventor: Kang-hoon Lee, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/847,466

(22) Filed: May 18, 2004

(30) Foreign Application Priority Data
May 28, 2003 (KR) 2003-34030

(51) Int. Cl. G06F 15/16

(52) U.S. Cl. 709/205; 709/208

(57) ABSTRACT

A method and apparatus to remotely control an electronic apparatus is provided. The method includes, connecting a plurality of electronic apparatuses to an Internet chatting server; displaying types of the plurality of electronic apparatuses connected with the Internet chatting server on a display screen of a client computer connected with the Internet chatting server; and transmitting a predetermined control command a predetermined electronic apparatus selected by a first user among the types of the plurality of the electronic apparatuses displayed on the display screen to the predetermined electronic apparatus, and controlling the predetermined electronic apparatus according to the predetermined control command or generating an error message to indicate that the predetermined electronic apparatus is not controlled. Therefore, the present invention allows remote control of electronic apparatuses over the Internet, without requiring exact Internet addresses of electronic apparatuses and without executing programs to drive the electronic apparatuses in a server with which the electronic apparatuses are connected.

### CROSS-REFERENCE TO RELATED APPLICATION

This application claims the priority of Korean Patent Application No. 2003-34030, filed on May 28, 2003, in the Korean Intellectual Property Office, the disclosure of which is incorporated herein in its entirety by reference.

### BACKGROUND OF THE INVENTION

1. Field of the Invention

The present invention relates to a method to remotely control electronic apparatuses over the Internet, and more particularly, to a method and apparatus to remotely-control electronic apparatuses of a client computer connected with an Internet chatting server.

2. Description of the Related Art

Electronic apparatuses (for example, computer peripherals) connected with a network, such as the Internet, are called network devices. One method to share such electronic apparatuses and access electronic apparatuses at different locations is to connect the electronic apparatuses to a web server on the Internet and form a network with client computers. The server is a computer, which controls connections of different computers on a network, to an entire or a portion of the network and to devices connected with the network.

The electronic apparatuses are indispensable portions of a computer, and similar to computer peripherals, are generally located near the computer. The electronic apparatuses include a printer, a multifunctional peripheral (MFP), an image scanner, a fax machine, a document server, etc. The client computers refer to processors that require services provided via different programs and/or devices over a network. The electronic apparatuses shared on the network have web programs or a server on the network includes programs to operate the electronic apparatuses. Generally, a web server connected with electronic apparatuses accesses a domain server of an Internet service provider (ISP) so that Internet protocol (IP) addresses or uniform resource locator (URL) addresses of the electronic apparatuses connected with the web server are shared, thereby allowing all client computers all over the world to access the electronic apparatuses. Here, the IP address is an address to identify transmission sources and transmission lines when communication is carried out through TCP/IP (Transmission Control Protocol/Internet Protocol), and the URL address is a standard logic address to display a web page on the Internet.

According to another method to share electronic apparatuses and access the electronic apparatuses at different locations, the electronic apparatuses have web servers, which are registered in an Internet Network Information Center (INIC), so that all client computers all over the world share the electronic apparatuses using domain names.

Generally, most electronic apparatuses have been shared through a web server. That is, to enable a user to remotely access and control electronic apparatuses located at the user's home from a different location, IP addresses or URL addresses of the electronic apparatuses should be registered to a web server and the web server should include various programs to drive the electronic apparatuses. Therefore, the following problems exist.

A user is required to know the exact IP addresses or URL addresses of shared electronic apparatuses in order to access the electronic apparatuses.

Further, because the web server includes various programs to drive the electronic apparatuses, a memory space of the web server must be large enough to accommodate various programs.

Additionally, an electronic apparatus with web server functions is more expensive than a general electronic apparatus, thus high expense is required to share the electronic apparatuses having the web server functions on the Internet.

### SUMMARY OF THE INVENTION

An aspect of the present invention provides a method to remotely control an electronic apparatus of a client computer connected with an Internet chatting server, which is connected with the electronic apparatus, without programs to drive the electronic apparatus.

Another aspect of the present invention provides an apparatus to remotely control an electronic apparatus using the method to remotely control the electronic apparatus.

According to an aspect of the present invention, there is provided a method to remotely control electronic apparatuses of a network, including a printer, a multifunctional device, a scanner, and a data server. The method comprises: connecting a plurality of electronic apparatuses to an Internet chatting server; displaying types of the plurality of electronic apparatuses connected with the Internet chatting server on a display screen of a client computer connected with the Internet chatting server; and transmitting a predetermined control command of a predetermined electronic apparatus selected by a first user among the types of the plurality of the electronic apparatuses displayed on the display screen to the predetermined electronic apparatus, and controlling the predetermined electronic apparatus according to the predetermined control command or generating an error message to indicate that the predetermined electronic apparatus is not controlled.

Additional aspects and/or advantages of the invention will be set forth in part in the description which follows and, in part, will be obvious from the description, or may be learned by practice of the invention.

According to another aspect of the present invention, an apparatus to remotely control an electronic apparatus using a remote control method is provided where the electronic apparatus includes a remote control apparatus, and the remote control apparatus comprises: a server connection processor to connect the electronic apparatus to an Internet chatting server; and a control command processor to control the electronic apparatus or generates an error message according to a control command transmitted from a client computer.

### BRIEF DESCRIPTION OF THE DRAWINGS

The above and/or other features and advantages of the invention will become more apparent and more readily appreciated from the following description of the embodiments, taken in conjunction with the attached drawings of which:

FIG. 1 shows a network environment to describe a method to remotely control an electronic apparatus according to an aspect of the present invention;

FIG. 2 is a flowchart to illustrate a method to remotely control an electronic apparatus according to an aspect of the present invention;

FIG. 3 is a flowchart to illustrate operation 100 of FIG. 2 according to an aspect of the present invention;

FIG. 4 is a flowchart to illustrate operation 104 of FIG. 2 according to an aspect of the present invention;

FIG. 5 is a flowchart to illustrate operation 104 of FIG. 2 according to another aspect of the present invention;

FIG. 6 is a block diagram of an apparatus to remotely control an electronic apparatus according to an aspect of the present invention;

FIG. 7 is a block diagram of a server connection processor of FIG. 6; and

FIG. 8 is a block diagram of a control command processor of FIG. 6.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout.

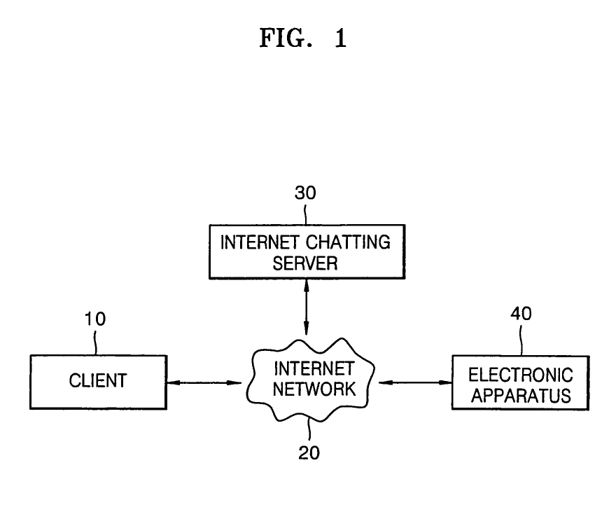

FIG. 1 shows a network environment to describe a method to remotely control an electronic apparatus according to an aspect of the present invention. The network environment includes: a client computer 10, an Internet network 20, an Internet chatting server 30, and an electronic apparatus 40. The client computer 10 includes a desktop computer, a notebook computer, or a personal digital assistant (PDA), etc. The Internet chatting server 30 is a server that implements multiple communications. A plurality of client computers access one Internet server and communicate to each other using text in real time. The electronic apparatus 40 has been described above and therefore the detailed description thereof is omitted.

As shown in FIG. 1, because the electronic apparatus 40 is connected with the Internet chatting server 30 via the Internet network 20, a network environment is formed so that the client computer 10 accesses the electronic apparatus 40.

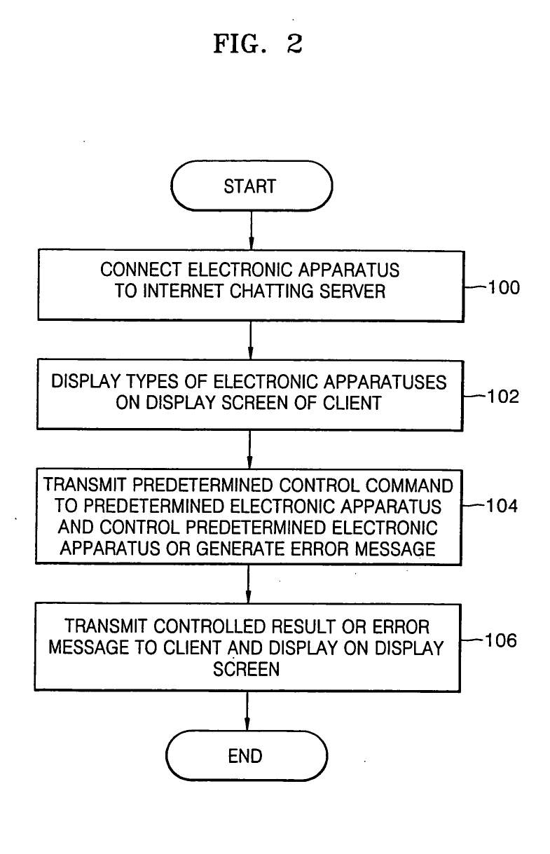

FIG. 2 is a flowchart to illustrate a method to remotely control the electronic apparatus according to an aspect of the present invention. The method to remotely control the electronic apparatus comprises operations 100 through 106, which transmit predetermined control commands to a predetermined electronic apparatus 40 connected with the Internet chatting server 30 and control the predetermined electronic apparatus 40.

First, an electronic apparatus 40 is connected with the Internet chatting server 30 in operation 100.

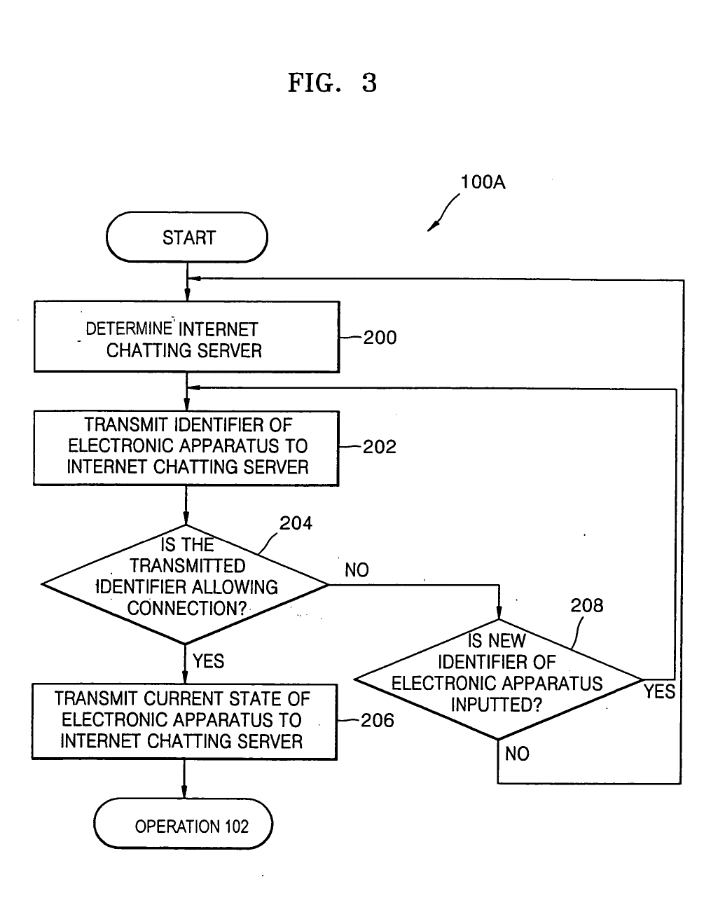

FIG. 3 is a flowchart to illustrate operation 100 of FIG. 2 according to an aspect of the present invention. Operation 100 includes operations s 200 through 208, which transmit an identifier of the electronic apparatus 40 to a predetermined Internet chatting server 30 and transmit current state information of the electronic apparatus 40 to the predetermined Internet chatting server 30 according to whether the transmitted identifier is an identifier that allows connection between the Internet chatting server 30 and the electronic apparatus 40.

First, an Internet chatting server 30 is determined in operation 200. Several well-known Internet chatting servers may be selected in advance and registered in the electronic apparatus 40. The Internet chatting server 30 that the electronic apparatus 40 will access is a server that includes identifier information, etc., of the electronic apparatus 40 in advance. Accordingly, when a user (referred to as a second user) selects an Internet chatting server 30 through a display screen of the electronic apparatus 40, the selected Internet chatting server 30 is determined as an Internet chatting server to access the electronic apparatus 40.

After operation 200, an identifier of the electronic apparatus 40 inputted by the second user is transmitted to the determined Internet chatting server 30 in operation 202. The identifier of the electronic apparatus 40 includes an identification (ID) and a password.

After operation 202, it is determined, in operation 204, whether the identifier of the electronic apparatus 40 transmitted to the Internet chatting server 30 is an identifier that allows connection between the Internet chatting server 30 and the electronic apparatus 40. The Internet chatting server 30 includes registration information of the electronic apparatus 40. Accordingly, by comparing an identifier of the electronic apparatus included in the registration information with an identifier transmitted from the electronic apparatus 40, it is determined whether the identifiers are the same.

When determined that the transmitted identifier is the identifier that allows connection between the Internet chatting server 30 and the electronic apparatus 40, current state information of the electronic apparatus 40 is transmitted to the Internet chatting server 30 in operation 206. The current state of the electronic apparatus 40 may be a standby state, or may be an operating state to indicate access by a different client computer and performance of a predetermined operation. The Internet chatting server 30 transmits the received current state of the electronic apparatus 40 to the client computer 10.

On the contrary, when determined that the transmitted identifier is not an identifier that allows connection between the Internet chatting server 30 and the electronic apparatus 40, it is determined, at operation 208, whether a new identifier of the electronic apparatus 40 is received from the second user. When a new identifier of the electronic apparatus 40 is received from the second user, operation 202 executed. And when no new identifier of the electronic apparatus 40 is received from the second user, operation 200 executed.

After operation 100, a type of the electronic apparatus 40 connected with the Internet chatting server 30 is displayed on the display screen of the client computer 10, which is also connected with the Internet chatting server 30, in operation 102. The client computer 10 accesses the Internet chatting server 30, and when the client computer 10 accesses the Internet chatting server 30, types of electronic apparatuses that access the Internet chatting server 30 and a list of different client computers that access the Internet chatting server 30 are displayed on a display screen of the client computer.

After operation 102, a predetermined control command for a predetermined electronic apparatus 40 selected by a user (referred to as a first user) among types of a plurality of the electronic apparatuses displayed on the display screen is transmitted to the selected electronic apparatus 40. The predetermined electronic apparatus 40 that receives the predetermined control command is controlled according to the predetermined control command. When the predetermined electronic apparatus can not be controlled, an error message to indicate that the predetermined electronic apparatus can not be controlled is generated in operation 104.

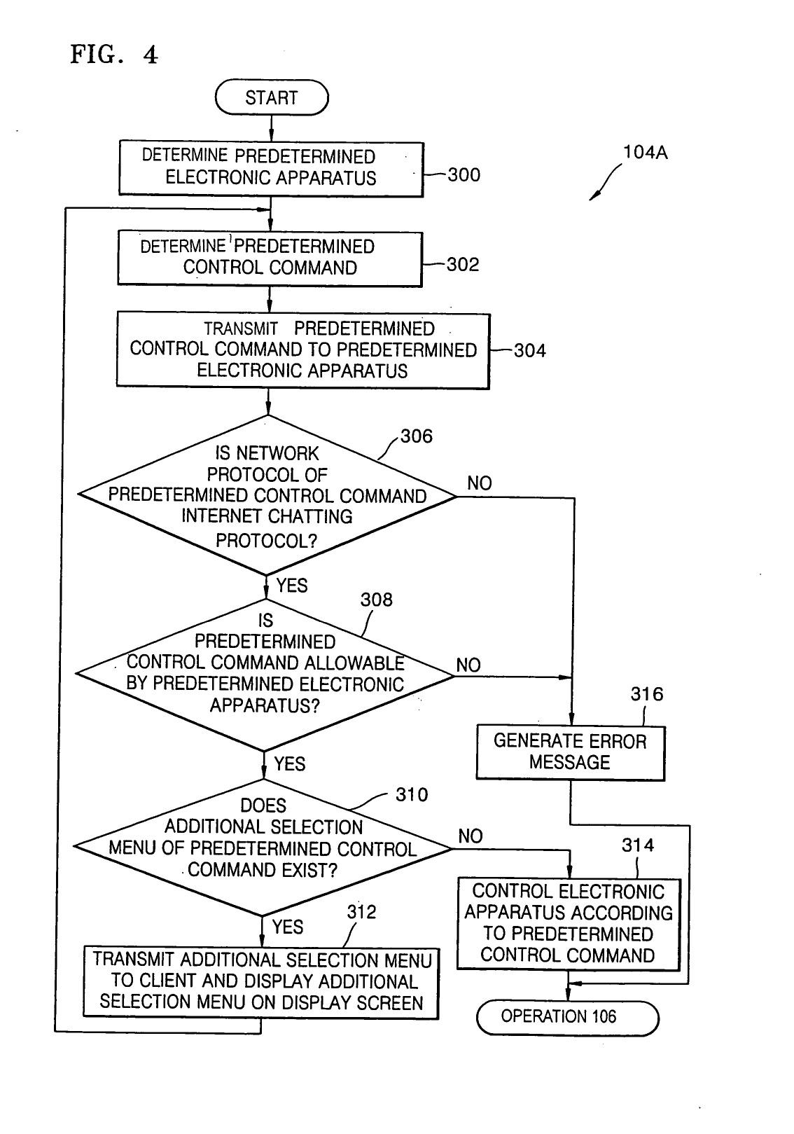

FIG. 4 is a flowchart to illustrate operation 104 of FIG. 2, according to an aspect of the present invention. Operation 104 includes operations 300 through 316 that control the predetermined electronic apparatus 40 or generate an error message based on whether a control command selected in a selection menu of control commands with an interactive message format is a network protocol or control command allowable by the predetermined electronic apparatus 40.

First, a predetermined electronic apparatus 40 is selected by the first user in operation 300. When a predetermined electronic apparatus 40 among a plurality of electronic apparatuses displayed on the display screen is selected by the first user, the predetermined electronic apparatus 40 is determined as an electronic apparatus 40 to be controlled by a client computer 10. According to an aspect of the present invention, a conversation window in which a control command is input is displayed on a display screen of the client computer 10.

After operation 300, a predetermined control command to control the predetermined electronic apparatus 40 is determined in operation 302. The predetermined control command includes a control command that is initially transmitted to the predetermined electronic apparatus 40 and a control command that is additionally transmitted. The control command initially transmitted to the predetermined electronic apparatus 40 is a control command that requires a selection menu of control commands including additional control commands for the electronic apparatus 40. According to an aspect of the present invention, the predetermined control command selected by the first user may be a control command that is initially transmitted to the predetermined electronic apparatus 40 or may be a control command selected in the selection menu of control commands received from the predetermined electronic apparatus 40. When a predetermined control command is selected by the first user, the predetermined control command is determined as a control command to control the predetermined electronic apparatus 40.

After operation 302, the predetermined control command is transmitted to the predetermined electronic apparatus in operation 304.

After operation 304, it is determined, in operation 306, whether the transmitted control command is an Internet chatting protocol. The Internet chatting protocol as a protocol to allow chatting on the Internet is based on a client/server model, and is implemented in a system using a TCP/IP network protocol. Accordingly, it is determined whether the control command has been transmitted by the Internet chatting protocol and is a protocol to allow chatting.

When it is determined that the network protocol of the transmitted control command is the Internet chatting protocol, it is determined, in operation 308, whether the transmitted control command is a control command allowable by the predetermined electronic apparatus 40. The predetermined electronic apparatus 40 includes control command data required for the electronic apparatus's own control. Accordingly, the electronic apparatus 40 determines whether the predetermined control command transmitted from the client computer 10 is one among the control command data, so that the electronic apparatus 40 determines whether the transmitted control command is a control command allowable by the electronic apparatus 40.

When it is determined that the transmitted control command is a control command allowable by the selected electronic apparatus, it is determined, in operation 310, whether there is an additional selection menu for the control command. According to an aspect of the present invention, the predetermined control command is a control command to directly control the predetermined electronic apparatus 40, or may be a control command that requires an additional selection menu, which belongs to a subgroup of the predetermined control command. According to an aspect of the present invention, the additional selection menu includes various selection items of additional control commands of the predetermined control command.

When an additional selection menu of the predetermined control command exists, the additional selection menu is transmitted to the client computer 10 and displayed on the display screen of the client computer 10 in operation 312, and then operation proceeds to operation 302.

On the contrary, when no additional selection menu of the predetermined control command exists, the predetermined electronic apparatus 40 is controlled according to the predetermined control command in operation 314. When no additional selection menu of the predetermined control command exists, the predetermined control command is a control command to directly control the predetermined electronic apparatus 40. Accordingly, the predetermined electronic apparatus 40 is controlled according to the predetermined control command.

Meanwhile, when it is determined that the network protocol of the transmitted control command is not an Internet chatting protocol or that the transmitted control command is not a control command allowable by the predetermined electronic apparatus 40, an error message is generated in operation 316. The error message indicates that the predetermined electronic apparatus 40 cannot be controlled by the transmitted control command.

FIG. 4 illustrates a method according to which the electronic apparatus 40 is controlled based on a control command with an interactive message format. Hereinafter, methods to control the predetermined electronic apparatus 40 according to a control command selected in a selection menu, including control commands, each with the interactive message format, according to an aspect of the present invention will be described.

As an example, a method in which a printer or a multifunctional device as an electronic apparatus 40 performs a printing operation will be described.

First, when an icon or a letter to indicate a printer or a multifunctional device among the types of the electronic apparatuses connected with the Internet chatting server 30 is selected by a user, a conversation window in which a control command to be transmitted to the printer or the multifunctional device is inputted is displayed on the display screen of the client computer 10.

For example, when a control command “Help” is input by the user, the “Help” control command is transmitted to the printer or multifunctional device through the Internet chatting server 30.

When the printer or multifunctional device receives the “Help” control command, as shown in FIG. 4, the printer or multifunctional device determines whether the “Help” control command is an Internet chatting protocol, and determines whether the “Help” control command is a control command allowable by the printer or the multifunctional device. Since the printer or the multifunctional device stores control command data, the printer or the multifunctional device determines whether the control command received from the client computer 10 is one among the control command data stored in the printer or the multifunctional device.

The control command data stored in the printer or the multifunctional device, for example, includes “Help”, “Get”, “Set”, and “Do” as control command data commonly used in all electronic apparatuses, and “Printer”, “Connect”, “Display”, and “Distribute” as control command data specifically used in a printer or a multifunctional device. According to an aspect of the present invention, control command data “Help” is a control command to indicate ‘transmit an additional selection menu of control commands capable of being provided by an electronic apparatus to a client computer 10’, “Get” is a control command to indicate ‘transmit characteristics or data of an electronic apparatus to a client computer 10’, and “Set” is a control command to indicate ‘transmit a response for characteristics or data of an electronic apparatus from a client computer 10 to the electronic apparatus 40’. Further, “Print” is a control command to indicate ‘print a file’, “Connect” is a control command to indicate ‘connect a printer or a multifunctional device to a different electronic apparatus’, “Display” is a control command to indicate ‘display a menu of a printer or a multifunctional device’, and “Distribute” is a control command to indicate ‘transmit a file of a printer or a multifunctional device to a different electronic apparatus’. These control commands may be different according to the types of electronic apparatuses, and also devices required to recognize and execute the control commands may be different according to the types of electronic apparatuses. According to an aspect of the present invention, the control commands may be transmitted in a format of a letter or in a format of a selection type menu. That is, the selection type menu is, for example, “1. Get, 2. Set, 3. Display”. The electronic apparatus 40 transmits the selection type menu to the client computer 10 so that a user selects from the selections numbered 1, 2, and 3.

The printer or the multifunctional device detects “1. main menu, 2. management menu, 3. help” as an additional selection menu of a control command of “Help” and transmits the additional selection menu to the client computer 10.

The transmitted additional selection menu, “1. main menu, 2. management menu, 3. help” is displayed on the display screen of the client computer 10.

When a control command corresponding to “1. main menu” of the additional selection menu is selected by the user, the selected control command is transmitted to the printer or the multifunctional device.

When the printer or the multifunctional device receives the control command of “1. main menu”, as shown in FIG. 4, it is determined whether a network protocol of the control command of “1. main menu” is an Internet chatting protocol and whether the control command of “1. main menu” is a control command allowable by the printer or the multifunctional device.

The printer or the multifunctional device detects “1. print a file, 2. search for a file, 3. transmit a fax, 4. see a list of received faxes”, etc., as an additional selection menu of the control command of “1. main menu” and transmits the detected result to the client computer 10.

The transmitted additional selection menu, “1. print a file, 2. search for a file, 3. transmit a fax, 4. see a list of received faxes” are displayed on the display screen of the client computer 10.

When a control command corresponding to “1. print a file” in the additional selection menu is selected by a user, the selected control command is again transmitted to the printer or the multifunctional device. At this time, a file to be printed is transmitted to the printer or the multifunctional device.

When the printer or the multifunctional device receives a control command of “1. print a file”, as shown in FIG. 4, it is determined whether a network protocol of the control command of “1. print a file” is an Internet chatting protocol and whether the control command of “1. print a file” is a control command allowable by the printer or the multifunctional device.

The printer or the multifunctional device prints the transmitted file according to the control command of “1. print a file”.

After the transmitted file is completely printed, a message to indicate that the transmitted file is printed is displayed on the display screen of the client computer 10.

According to an aspect of the present invention, when printing the file, a control command that requires that a printer or a multifunctional device receive a file from a data server as an electronic apparatus and print the file is generated, or a control command that requires that a plurality of printers or multifunctional devices print the same file at a time is generated.

According to an aspect of the present invention, a method to call up a file from a document server as an electronic apparatus will be described.

First, when an icon or a letter representing a document server among the types of the electronic apparatuses connected with the Internet chatting server 30 is selected by the user, a conversation window in which a control command to be transmitted to the document server is inputted is displayed on the display screen of the client computer 10.

When a control command “Help” is input by the user, the “Help” control command is transmitted to the document server through the Internet chatting server 30.

When the document server receives the control command “Help”, as shown in FIG. 4, it is determined whether a network protocol of the control command “Help” is an Internet chatting protocol and whether the control command of “Help” is a control command allowable by the document server. Since the document server stores control command data, the document server determines whether a control command input by the client computer 10 is one among the control command data stored in the document server. The control command data stored in the document server, for example, includes “Help”, “Get”, “Set”, and “Do” as control command data commonly used in all electronic apparatuses, and control command data specifically used in the document server.

The document server detects “1. main menu, 2. management menu, 3. help”, etc. as an additional selection menu of the control command of “Help”, and transmits the detected result to the client computer 10.

The transmitted additional selection menu, “1. main menu, 2. management menu, 3. help”, etc. are displayed on the display screen of the client computer 10.

When a control command corresponding to “1. main menu” of the additional selection menu is selected by the user, the selected control command is again transmitted to the document server.

When the document server receives the control command of “1. main menu”, as shown in FIG. 4, it is determined whether a network protocol of the control command of “1. main menu” is an Internet chatting protocol and whether the control command of “1. main menu” is a control command allowable by the document server.

The document server detects “1. see a list of files, 2. see a list of servers”, etc., as an additional selection menu of “1. main menu”, and transmits the detected result to the client computer 10.

The transmitted additional selection menu “1. see a list of files, 2. see a list of servers”, etc. are displayed on the display screen of the client computer 10.

When a control command corresponding to “1. see a list of files” in the additional selection menu is selected by a user, the selected control command is again transmitted to the document server.

When the document server receives the control command of “1. see a list of files’, as shown in FIG. 4, it is determined whether a network protocol of the control command of “1. see a list of files+ is an Internet chatting protocol and whether the control command of “1. see a list of files” is a control command allowable by the document server.

The document server detects a list stored in the document server according to the control command of “1. see a list of files” and transmits the detected result to the client computer 10.

The transmitted list of files is displayed on the display screen of the client computer 10.

When a file among the displayed list of files is selected by a user and a control command “Get” for the selected file is decided, the “Get” control command for the selected file is again transmitted to the document server.

When the document server receives the “Get” control command for the selected file, as shown in FIG. 4, it is determined whether the network protocol of the control command of “Get” is an Internet chatting protocol and whether the control command of “Get” is a control command allowable by the document server.

The document server transmits the selected file to the client computer 10 according to the “Get” control command for the selected file.

Then, a message to indicate that the selected file has been transmitted to the client computer 10 is displayed on the display screen of the client computer 10.

Meanwhile, the client computer 10 calls up a file scanned by a multifunctional device, etc., or a file transmitted through a facsimile using the same method as that used in the document server, and executes the “see a list” option to display the file.

According to an aspect of the present invention, the client computer 10 is informed of a current state of an electronic apparatus. When the electronic apparatus 40 is connected with an Internet chatting server 30, a current state of the electronic apparatus 40 at the connection time is transmitted to the Internet chatting server 30, and the current state of the electronic apparatus transmitted to the Internet chatting server 30 is displayed on the display screen of the client computer 10. The current state of the electronic apparatus 40 is periodically displayed on the display screen of the client computer 10. At this time, a user requests a detailed current state of the electronic apparatus 40. When the user requests a detailed current state of the electronic apparatus 40, the detailed current state of the electronic apparatus 40 is displayed on the display screen of the client computer 10.

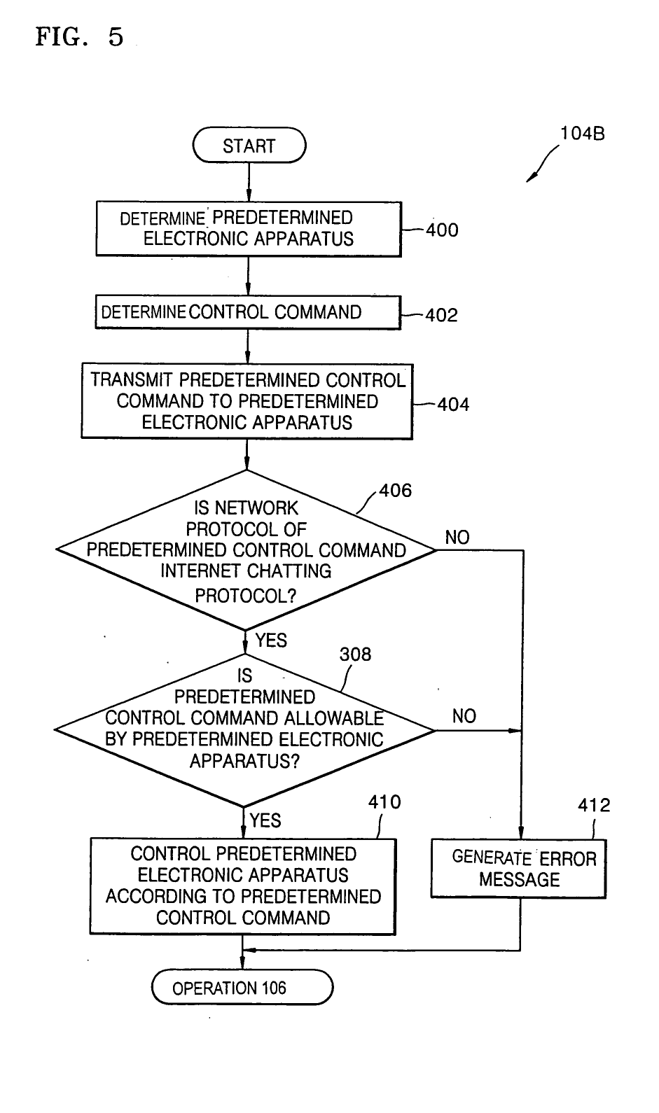

FIG. 5 is a flowchart to illustrate operation 104 of FIG. 2, according to an aspect of the present invention, where the operation comprises operations 400 through 412 that control an electronic apparatus 40 or generate an error message according to whether a control command selected in a menu window of control commands is a network protocol or control command allowable by a predetermined electronic apparatus 40.

First, a user selects a predetermined electronic apparatus 40 in operation 400. When a predetermined electronic apparatus 40 is selected, a menu window of control commands output from the predetermined electronic apparatus 40 is transmitted to the client computer 10 and is displayed on the display screen of the client computer 10. In contrast to the above-described selection menu with the interactive message format, the menu window of the control commands allows a first user to select control commands at a time. This is different from the aspect of the present invention shown in FIG. 4 that provides the control command with the interactive format because control commands selected by the first user are transmitted to the predetermined electronic apparatus 40 at the same time.

After operation 400, a predetermined control command to control the predetermined electronic apparatus 40 is determined in operation 402. A control command, which the first user selects in the menu window of control commands displayed on the display screen of the client computer 10, is determined as a control command to control the predetermined electronic apparatus 40.

After operation 402, the predetermined control command is transmitted to the predetermined electronic apparatus 40 in operation 404.

After operation 404, it is determined whether a network protocol of the transmitted control command is an Internet chatting protocol in operation 406.

When it is determined that the network protocol of the transmitted control command is an Internet chatting protocol, it is determined in operation 408 whether the transmitted control command is a control command allowable by the predetermined electronic apparatus 40.

When it is determined that the transmitted control command is a control command allowable by the predetermined electronic apparatus, the predetermined electronic apparatus 40 is controlled according to the control command in operation 410.

However, when it is determined that the network protocol of the transmitted control command is not the Internet chatting protocol or that the transmitted control command is not the control command allowable by the predetermined electronic apparatus 40, an error message is generated in operation 412.

After operation 412, a controlled result or a generated error message is transmitted from the electronic apparatus 40 to the client computer 10 and is displayed on the display screen of the client computer 10 in operation 106. That is, a controlled result of the predetermined electronic apparatus controlled by the control command or an error message to indicate that the electronic apparatus cannot be controlled by the control command is displayed on the display screen of the client computer 10.

Hereinafter, a remote controller of the electronic apparatus according to an aspect of the present invention will be described.

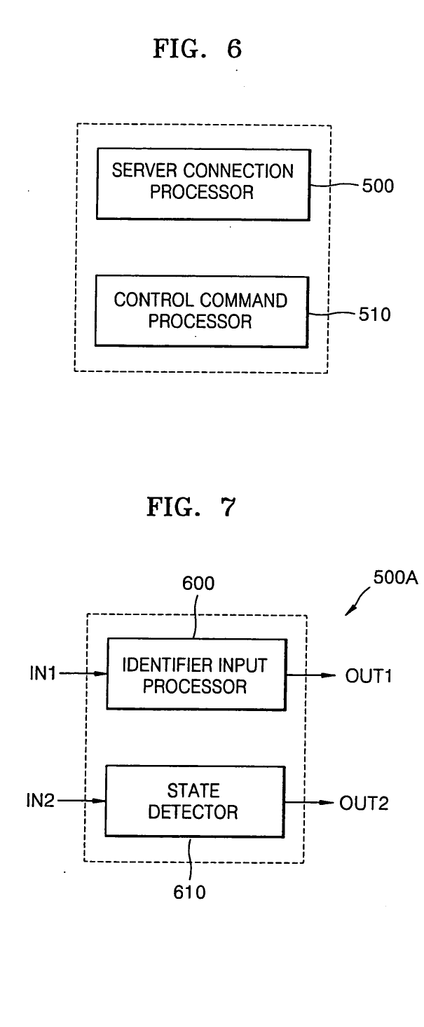

FIG. 6 is a block diagram of a remote controller of an electronic apparatus, according to an aspect of the present invention, where the electronic apparatus includes a server connection processor 500 and a control command processor 510.

The server connection processor 500 connects an electronic apparatus 40 to an Internet chatting server 30.

FIG. 7 is a block diagram of the server connection processor 500 of FIG. 6, according to an aspect of the present invention. The server connection processor 500 includes an identifier input processor 600 and a state detector 610.

The identifier input processor 600 transmits an identifier of the electronic apparatus 40 received from a second user to an Internet chatting server 30. The identifier input processor 600 transmits an identifier including an ID and a password of the electronic apparatus 40 received from the second user through an input terminal IN1 to an Internet chatting server 30 through an output terminal OUT1. Because the Internet chatting server 30 stores registration information of the electronic apparatus 40, the Internet chatting server 30 compares an identifier of the electronic apparatus 40 included in the registration information with an identifier transmitted from the electronic apparatus 40.

The state detector 610 detects a current state of the electronic apparatus 40 and transmits the detected result to the Internet chatting server 30. The state detector 610 receives a compared result of the identifier of the selected electronic apparatus included in the registration information of the Internet chatting server 30 and the identifier transmitted from the selected electronic apparatus from the Internet chatting server 30 through an input terminal IN2. The state detector 610 detects a current state of the electronic apparatus 40 in response to the compared result and transmits the detected result to the Internet chatting server 30 through an output terminal OUT2.

The control command processor 510 controls the predetermined electronic apparatus or generates an error message according to the control command transmitted from the client computer 10.

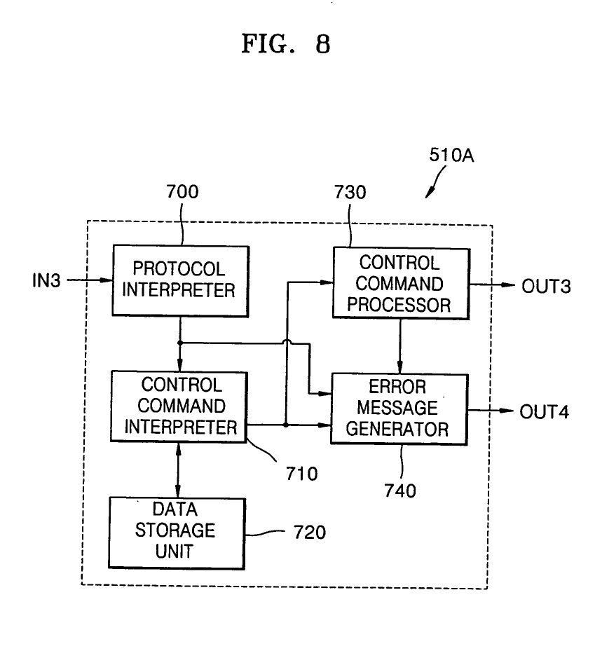

FIG. 8 is a block diagram of the control command processor 510 of FIG. 6 according to an aspect of the present invention. The control command processor 510 includes a protocol interpreter 700, a control command interpreter 710, a data storage unit 720, a control command processor 730, and an error message generator 740.

The protocol interpreter 700 determines whether a network protocol of a transmitted control command is an Internet chatting protocol. A determined result output from the protocol interpreter 700 is categorized into a case where the network protocol of the control command is the Internet chatting protocol and a case where the network protocol of the control command is not the Internet chatting protocol. The protocol interpreter 700 determines whether a network protocol of a predetermined control command received through an input terminal IN3 is an Internet chatting protocol, and outputs the determined result to the control command interpreter 710 and the error message generator 740.

The control command interpreter 710 determines whether the transmitted control command is a control command allowable by the predetermined electronic apparatus 40. The control command interpreter 710 determines whether the transmitted control command is a control command allowable by the predetermined electronic apparatus in response to the determined result received from the protocol interpreter 700, and outputs the determined result to the control command processor 730 and the error message generator 740. To determine whether the transmitted control command is a control command allowable by the predetermined electronic apparatus 40, the control command interpreter 710 checks the data storage unit 720 to determine whether data corresponding to the transmitted control command exists therein, and outputs a message to indicate that the transmitted control command is a control command allowable by the predetermined electronic apparatus 40 when the required control command data exists.

The data storage unit 720 stores control command data including predetermined control commands, and a list of electronic apparatuses connected with the Internet chatting server 30. The data storage unit 720 provides predetermined control command data in response to a request for control command data received from the control command interpreter 710. The predetermined electronic apparatus 40 is connected with different electronic apparatuses and executes the control command through signal communication with the different electronic apparatuses. Accordingly, the data storage unit 720 stores registration information of different electronic apparatuses.

The control command processor 730 controls the predetermined electronic apparatus 40 according to a predetermined control command or detects an additional selection menu of the predetermined control command. The control command processor 730 controls the predetermined electronic apparatus 40 according to the predetermined control command in response to the determined result output from the control command interpreter 710 or detects an additional selection menu of the predetermined control command, and outputs the result through an output terminal OUT3. The additional selection menu of the predetermined control command is detected in an interactive message format when the predetermined electronic apparatus 40 is controlled by the predetermined control command. A controlled result of the predetermined electronic apparatus 40 output through the output terminal OUT3 is transmitted to the client computer 10, and is displayed on the display screen of the client computer 10.

The error message generator 740 generates an error message in response to the determined result output from the protocol interpreter 700 or in response to the determined result output from the control command interpreter 710. The error message generated from the error message generator 740 indicates that the predetermined electronic apparatus 40 cannot be controlled by the predetermined control command. The error message generator 740 outputs the generated error message through an output terminal OUT4. The error message output through the output terminal OUT4 is transmitted to the client computer 10 and is displayed on the display screen of the client computer 10.

As described above, according to the present invention, it is possible to remotely control electronic apparatuses over the Internet without requiring exact Internet addresses of the electronic apparatuses and without executing programs to drive the electronic apparatuses in a server to which the electronic apparatuses are connected.

Although a few embodiments of the present invention have been shown and described, it would be appreciated by those skilled in the art that changes may be made in this embodiment without departing from the principles and spirit of the invention, the scope of which is defined in the claims and their equivalents.

1. A method to remotely control electronic apparatuses of a network, the method comprising:
connecting the electronic apparatuses to an Internet chatting server;
displaying types of the electronic apparatuses connected with the Internet chatting server on a display screen of a client computer connected with the Internet chatting server; and
transmitting a predetermined control command of a selected one of the electronic apparatuses selected by a first user among the types of the electronic apparatuses displayed on the display screen to the selected electronic apparatus, and controlling the selected electronic apparatus according to the predetermined control command or generating an error message indicating that the selected electronic apparatus is not controlled.

2. The method according to claim 1, wherein the connecting of the electronic apparatuses to the Internet chatting server comprises:
determining the Internet chatting server;
transmitting an identifier of the selected electronic apparatus inputted by a second user to the determined Internet chatting server;
determining whether the transmitted identifier is an identifier that allows a connection between the Internet chatting server and the selected electronic apparatus;
transmitting a current state of the selected electronic apparatus from the electronic apparatus to the Internet chatting server upon determining that the transmitted identifier is the identifier that allows the connection between the Internet chatting server and the electronic apparatus; and
determining whether a new identifier of the selected electronic apparatus is input by the second user upon determining that the transmitted identifier is not the identifier that allows the connection between the Internet chatting server and the selected electronic apparatus.

3. The method according to claim 1, wherein transmitting of the predetermined control command of the selected electronic apparatus comprises:
determining the selected electronic apparatus;
determining a predetermined control command to control the selected electronic apparatus;
transmitting the predetermined control command to the selected electronic apparatus;
determining whether a network protocol of the transmitted control command is an Internet chatting protocol;
determining whether the transmitted control command is a control command allowable by the selected electronic apparatus upon determining that the network protocol of the transmitted control command is the Internet chatting protocol;
determining whether an additional selection menu of the predetermined control command exists upon determining that the transmitted control command is the control command allowable by the selected electronic apparatus;
transmitting the additional selection menu to the client computer, displaying the additional selection menu on the display screen, and determining a predetermined control command to control the selected electronic apparatus upon determining that the additional selection menu of the predetermined control command exists;
controlling the selected electronic apparatus according to the predetermined control command upon determining that the additional selection menu of the predetermined control command does not exist; and
generating an error message upon determining that the network protocol of the transmitted control command is not the Internet chatting protocol or that the transmitted control command is not the control command allowable by the selected electronic apparatus.

4. The method according to claim 1, wherein transmitting of the predetermined control command of the selected electronic apparatus comprises:
determining the selected electronic apparatus;
determining the predetermined control command to control the selected electronic apparatus;
transmitting the predetermined control command to the selected electronic apparatus;
determining whether a network protocol of the transmitted control command is an Internet chatting protocol;
determining whether the transmitted control command is a control command allowable by the selected electronic apparatus upon determining that the network protocol of the transmitted control command is the Internet chatting protocol;
controlling the selected electronic apparatus according to the predetermined control command upon determining that the transmitted control command is the control command allowable by the selected electronic apparatus; and
generating an error message upon determining that the network protocol of the transmitted control command is not the Internet chatting protocol or that the transmitted control command is not the control command allowable by the selected electronic apparatus.

5. The method according to claim 1, further comprising:
transmitting a controlled result or the generated error message from the selected electronic apparatus to the client computer and displaying the controlled result or the generated error message on the display screen of the client computer upon transmitting the predetermined control command for the selected electronic apparatus.

6. The method according to claim 1, wherein the predetermined control command is to print a file, to call up a file, or to confirm a state of the selected electronic apparatus.

7. An apparatus to remotely control an electronic apparatus connected with a client computer that is connected with an Internet chatting server, comprising:
a server connection processor to connect the electronic apparatus to the Internet chatting server; and
a control command processor to control the electronic apparatus or generate an error message according to a control command transmitted from the client computer.

8. The apparatus according to claim 7, wherein the server connection processor comprises:
an identifier input processor to transmit an identifier of the electronic apparatus received from a user to the Internet chatting server; and
a state detector to detect a current state of the electronic apparatus and transmit the detected result to the Internet chatting server.

9. The apparatus according to claim 7, wherein the control command processor comprises:
a protocol interpreter to determine whether a network protocol of the transmitted control command is an Internet chatting protocol;
a data storage unit to store control command data including a predetermined control command and a list of different electronic apparatuses connected with the Internet chatting server;
a control command interpreter to determine whether the transmitted control command is a control command allowable by the electronic apparatus;
a control command processor to control the electronic apparatus according to the predetermined control command or to detect an additional selection menu of the predetermined control command; and
an error message generator to generate the error message in response to a determined result output from the protocol interpreter and a determined result output from the control command interpreter.

10. The method according to claim 2, wherein the identifier of the predetermined electronic apparatus is registered in the Internet chatting server, and the transmitted identifier of the predetermined electronic apparatus is compared with the registered identifier to determine whether the transmitted identifier is an identifier that allows a connection between the Internet chatting server and the predetermined electronic apparatus.

11. The method according to claim 2, wherein the current state of the electronic apparatus is periodically displayed on the display screen of the client computer.

12. The apparatus according to claim 8, wherein the Internet chatting server stores registration information of the electronic apparatus, and compares the identifier of the electronic apparatus received from the user with the registration information.

13. A method to remotely control electronic apparatuses of a network, comprising:
displaying types of the electronic apparatuses connected with the network on a display screen of a client computer; and
transmitting a predetermined control command of a selected one of the electronic apparatuses to the selected electronic apparatus, and controlling the selected electronic apparatus according to the predetermined control command or generating an error message to indicate that the selected electronic apparatus is not controlled.

14. A remote control apparatus to remotely control electronic apparatuses that are connected with a network, comprising:
an identifier input processor to transmit an identifier of a selected electronic apparatus via the network; and
a control command processor to control the selected electronic apparatus, and to generate an error message according to the identifier transmitted.

15. The remote control apparatus according to claim 1, wherein the selected electronic apparatus stores control command data, and the selected electronic apparatus determines whether the transmitted identifier is the control command data stored in the selected electronic apparatus.

16. The remote control apparatus according to claim 13, wherein the error message is generated upon determining that the transmitted identifier is not the control command data stored in the selected electronic apparatus.

17. The remote control apparatus according to claim 1, further comprising:
a state detector to detect a current state of the selected electronic apparatus and transmit the detected state via the network.

18. The remote control apparatus according to claim 1, wherein the identifier of the electronic apparatus includes identification and password information.

19. A method to remotely control electronic apparatuses of a network, comprising:
transmitting a predetermined control command of a selected electronic apparatus to the selected electronic apparatus via the network; and
controlling the selected electronic apparatus according to the predetermined control command or generating an error message to indicate that the selected electronic apparatus is not controlled.

20. An apparatus to remotely control an electronic apparatus connected with an Internet chatting server, comprising:
a control command processor to control the electronic apparatus, wherein the control command processor controls the electronic apparatus without using an exact Internet address of the electronic apparatus, and without executing programs to drive the electronic apparatus.
